(19) United States
(12) Patent Application Publication
(10) Pub. No.: US 2011/0217427 A1
(43) Pub. Date: Sep. 8, 2011

(54) CONFECTIONERY AND METHODS OF PRODUCTION THEREOF

(76) Inventors: Shama Karu Vaman, London (GB); Sarah Jayne Prestwood Pearson, Canberra (AU); Clive Richard Thomas Norton, Shinfield (GB)

(21) Appl. No.: 13/120,490

(22) PCT Filed: Sep. 22, 2009
(86) PCT No.: PCT/GB2009/002248

§ 371 Date: May 23, 2011

(30) Foreign Application Priority Data
Sep. 23, 2008 (GB) 0817366.8

(51) Int. Cl. A23G 3/54; A23P 1/00; A23P 1/12; A23P 1/08

(52) U.S. Cl. 426/103; 426/660; 426/514; 426/284; 426/302

(57) ABSTRACT

The present invention relates to a confectionery product comprising an extruded body portion, the body portion having three or more capillaries disposed therein which extend substantially parallel to one another in two or more different planes, the capillaries being distributed in groups at one or more locations within the body portion and/or distributed around the periphery of the body portion. The invention also relates to a process of manufacturing the same.

### TECHNICAL FIELD OF THE INVENTION

The present invention relates to confectionery and method of production thereof. In particular, the invention relates to confectionery comprising a plurality of capillaries which may contain a fluid.

BACKGROUND TO THE INVENTION

It is desirable to produce confectionery formed of different components, so as to increase sensory pleasure. A number of confectionery products exist, which have a flavoured liquid or syrup centre which is released upon chewing. For example, WO2007056685 discloses an apparatus and method for the continuous production of centre-filled confectionery products in the format of a continuous extrudate having a plurality of centre-filled confectionery ropes. Whilst a product formed from such an apparatus does increase sensory pleasure, the period of pleasure is often short lived as the centre is released quickly and/or degraded. It is therefore an object of the present invention to provide a confectionery product which can release a fluid centre over an extended period of time.

There is also a demand for providing confectionery having a reduced fat or sugar content. It is thus a further object of the present invention to provide a confectionery product which can be produced having a lowered fat or sugar content, whilst still maintaining an excellent sensory pleasure.

It is an aim of an embodiment or embodiments of the present invention to overcome one or more of the problems of the prior art. It is also an aim of one of the embodiments of the present invention to provide a confectionery having an extended fluid fill release profile and a method of manufacture thereof. It is also a further aim of the present invention to provide a confectionery which has a reduced fat and/or sugar profile and a method of manufacture thereof.

### SUMMARY OF THE INVENTION

According to an embodiment of the present invention, there is provided a confectionery product comprising an extruded body portion, the body portion having three or more capillaries disposed therein which extend substantially parallel to one another in two or more different planes.

The present invention therefore provides for a confectionery product which can be used in confectionery having an extended release of a material inserted into the capillaries, or a confectionery product having a large voidage so as to reduce the amount confectionery material used in the product, whilst maintaining the overall size of the product.

The term “plane” should be taken to mean is usual geometric meaning which refers to a substantially flat dimension.

In some embodiments, the capillaries may be distributed throughout the extruded body portion in a number of configurations. For example, the capillaries may be distributed throughout the extruded body portion at one or more locations within the body portion. In other embodiments, the capillaries may be distributed in pre-defined configurations within the body portion, such as around the periphery of the body portion, or in groups at one or more locations within the body. The capillaries may be distributed around the periphery of the body portion. The capillaries may be distributed throughout the body portion in a substantially circular, semi-circular, elliptical or polygonal configuration. In an alternative embodiment, the capillaries may be distributed substantially uniformly throughout the body portion and they may be spaced evenly apart from adjacent capillaries. In other embodiments, the capillaries are distributed in the body portion so as to form an outline of an object, cartoon character or animal.

The material used to produce the body portion may comprise a number of materials commonly use in the production of confectionery—such as candy, gum and chocolate etc.

In some embodiments, the body portion is chocolate. Suitable chocolate includes dark, milk, white and compound chocolate. In some embodiments, the body portion is chewing gum, bubble gum or gum base. In other embodiments, the body portion is candy. Suitable candy includes hard candy, chewy candy, gummy candy, jelly candy, toffee, fudge, nougat and the like.

The capillaries may extend along the substantially entire length of the body portion, but may in some embodiment extend no less than 75%, 80%, 90%, 95% or 99% along the length of the body portion (for example, when it is desired to seal the ends of the body portion). If the capillaries extend along the entire length of body portion, suitably the ends of the capillaries are visible at one or more ends of the body portion.

One or more of the capillaries may be filled with a material which is different from that of the material used to form the body portion. Different capillaries may incorporate different materials if desired. The capillaries may be filled with a fluid material. Such a fluid may comprise a liquid. The capillaries may be filled with a material which is solid at a room temperature and fluid at a temperature greater than room temperature. For example, a molten chocolate may be incorporated into the capillaries and allowed to set when cooled to room temperature. It will be apparent to the skilled addressee that room temperature is commonly regarded as around 20° C. Alternatively, the capillaries may be filled with a material which is deposited as a liquid and which subsequently solidifies. In such embodiments, the solidification may be dependent or independent of heat. It will be apparent that solidification of a liquid filled capillary may be achieved in a number of ways. For example solidification may take place due to one or more of the following:
Cooling—the filling may be molten when deposited which then cools to a solid at room temperature;
Heating—the filling may be liquid when deposited, and the heat of the extruded body portion sets the filling (e.g. pumping egg albumen into a hot hard candy extruded body portion will set the egg on contact);
Drying—the filling may be a solution that dries into a solid (e.g. the moisture from the solution is absorbed into the extruded body portion);
Solvent loss—the filling may be in a solvent, whereby the solvent is absorbed into the extruded body portion, leaving a solid;
Chemical reaction—the filling may be deposited as a liquid but reacts or “goes off” into a solid;
Cross-linking—the filling may form a constituents for a cross-linked material due to mixing and/or heating; and
Time—the filling may simply set with time (e.g. a solution of sugars and gelatin will eventually set over time).

Suitable filling materials for the capillaries include, but are not limited to, aqueous media, fats, chocolate, caramel, cocoa butter, fondant, syrups, peanut butter, jam, jelly, gels, truffle, praline, chewy candy, hard candy or any combination or mixture thereof.

If desired, the product may further comprise a coating portion to envelop the body portion. The skilled addressee will appreciate that a number of coatings could be employed—for example chocolate, gum, candy and sugar etc.

The body portion may be connected to one or more further confectionery portions. In some embodiments, the body portion is sandwiched between confectionery materials or may be connected or laminated to one or more confectionery layers. The further confectionery portion or portions may or may not contain inclusions, liquid-filled beads etc.

The product may further comprise a centre fill. In one embodiment, the centre fill is at least partially surrounded by the capillaries. If desired, the centre fill may be surrounded by the capillaries. The centre fill may comprise a number of fill materials known to the skilled addressee. In an embodiment, the centre fill comprises a liquid centre fill.

The body portion may be shaped in the form of a cylinder, a rope, a filament, a strip, a ribbon or the like, or may be shaped in the form of a standard confectionery product such a chocolate bar, or chewing gum slab, pellet, ball, stick or ribbon, for example. The body portion may be irregular or regular in shape. Furthermore, the body portion may be formed in potentially any shape, for example in the shape of an object, cartoon character or an animal to name a few. The shape of the body portion may be generally rounded or polygonal in cross-section.

The capillaries may have different widths or diameters. Such an arrangement will allow, if desired, for different quantities of different fill materials to be incorporated into different capillaries. Furthermore, the capillaries may have different cross-sectional profiles. For example, the confectionery product may have capillaries having a cross-sectional shapes including stars and triangles, or different shapes of animals etc.

The body portion may incorporate a central cavity. If such a central cavity is provided, it may have a width or diameter which is larger than the capillaries.

In an embodiment, the capillaries in the body portion result in a voidage in the range of 1-99% of the extrudate, or of 5-99% of the extrudate. The voidage may be in the range of 10-60%, 20-50%, 30-45%, or 35-40%. The voidage may also be in intermediate points in these ranges, for example, 5-40%, 5-45%, 5-50%, 5-60%, 10-40%, 10-45%, 10-50%, 10-99%, 20-60%, 20-45%, 20-40%, 20-60%, 20-99%, 30-40%, 30-50%, 30-60% or 30-99%. The voidage may be over 5%, 10%, 15%, 20%, 25%, 30%, 35%, 40%, 45%, 50%, 55%, 60%, 65%, 70%, 75%, 80%, 85%, 90% or 95%.

The incorporation of capillaries of a small cross-sectional width or diameter enables the capillaries to entrain contrasting or complementary confectionery materials into the body portion whilst avoiding the need to incorporate large centre-fill areas which may be prone to leakage through, or out of, the confectionery product. The use of a plurality of capillaries also enables two or more materials to be incorporated into the confectionery product to give multiple textures, tastes, colours and/or mouth-feel sensations, throughout the whole confectionery product.

In some embodiments, the capillaries have an average diameter or width of no more than, 3 mm, 2 mm, 1 mm, 0.5 mm, 0.25 mm or less. It is possible to have capillaries having a diameter or width of no more than 100 μm, 50 μm or 10 μm. The capillaries may have different widths or diameters if desired.

The material of the body portion will preferably be liquid during extrusion. It should be understood that the term “liquid” is intended to mean that the material is capable or has a readiness to flow, including gels, pastes and plasticized chocolate. Furthermore, this term is intended to include (but not limited to) those materials which may be “molten” during extrusion and the skilled addressee will understand that the term “molten” means that the material has been reduced to a liquid form or a form which exhibits the properties of a liquid. The body portion may be at least partially or substantially solid, so that it can no longer be considered to flow in a liquid form.

In another embodiment of the present invention, there is provided a confectionery product comprising a first extruded portion and a second extruded portion, wherein each portion has a plurality of capillaries disposed therein, and the capillaries of the first and second portions are:
a) discontinuous; and/or
b) continuous and oriented in more than one direction.

There may be further portions in addition to the first and second portions, which may or may not comprise capillaries. In one embodiment, the confectionery product comprises the first portion separated from the second portion by one or more further portions that may or may not contain capillaries.

The first and second portions may be as described hereinabove for the body portion. The first and second portions may comprise the same material or different materials. For example, the first portion may be chocolate and the second portion candy. The capillaries in each of the first and second portions may be filled with the same or different materials. One or more capillaries in the first and/or second portions may be filled with different material(s) to other capillaries in the first and/or second portion.

According to a further embodiment of the invention, there is provided a confectionery product comprising an extruded body portion having a plurality of capillaries disposed therein, wherein each capillary is separated from each adjacent capillary by a wall formed from the extruded body portion and wherein the wall between each capillary has a thickness of no more than the width or diameter of the capillaries.

According to a further embodiment, there is provided a process for manufacturing a confectionery product comprising a body portion, having a plurality of capillaries disposed therein, the process comprising the step of:
a) extruding an extrudable confectionery material with three or more capillaries disposed therein which extend substantially parallel to one another in two or more different planes, the capillaries being distributed in groups at one or more locations within the body portion and/or distributed around the periphery of the body portion.

In some embodiments, the method may include an extra step selected from:
b) cutting the extrudate into two or more pieces having a plurality of capillaries disposed therein and forming a confectionery product incorporating the pieces; and/or
c) folding the extrudate and forming a confectionery product incorporating the folded extrudate.

According to a further embodiment, there is provided a process for manufacturing a confectionery product comprising a body portion, having a plurality of capillaries disposed therein, the process comprising the steps of:
a) extruding an extrudable confectionery material with a plurality of capillaries disposed therein; and
b) cutting the extrudate into two or more pieces having a plurality of capillaries disposed therein and forming a confectionery product incorporating the pieces; or
c) folding the extrudate and forming a confectionery product incorporating the folded extrudate

Any of the above processes may further comprise the step of depositing a filling in at least part of one or more of the capillaries. The deposition of the filling may be during the step of extrusion—but could also take place after extrusion. In an embodiment, the filling comprises a fluid. The fluid may comprises a liquid, or a material which is liquid at a temperature greater than room temperature.

Any of the processes may further comprise the step of quench cooling the extrudate after extrusion. The quench cooling may utilise a fluid such as air, an oil or liquid nitrogen—but other methods of quench cooling will also be apparent to the skilled addressee.

Any of the processes may further comprise the step of, after extrusion, stretching the extrudate. Stretching the extrudate may be undertaken by a number of means, for example passing the extrudate over, or through conveyor belts or rollers operating at different speeds, so as to stretch the extrudate. By employing this additional step, extrusions having capillaries of a larger diameter can be produced, which can be reduced in diameter gradually over time, so as to produce an extrudate with smaller capillaries which would have been more difficult to produce initially. Commonly, capillaries having a bore size of 2 mm or more will be produced during extrusion and these capillaries will be reduced significantly by stretching the extrudate. In some embodiments the capillaries are reduced to no more than 1 mm, 0.5 mm, 0.25 mm, 100 μm, 50 μm, 25 μm or 10 μm.

Any of the processes may further comprise the step of enveloping the confectionery product in a coating. Such a coating will be apparent to the skilled addressee and discussed previously.

The extrudable confectionery material will at least partially or substantially solidify after extrusion.

If desired, two or more capillaries may be formed having different widths or diameters. Furthermore, two or more of the capillaries may be formed having different cross-sectional profiles.

The body portion may be formed with a central cavity which has a width or diameter which is larger than the capillaries. The cavity may be filled with a centre fill. The cavity may be filled with the centre fill during extrusion of the body portion.

The processes may be used for producing a confectionery material as herein above described.

A further embodiment of the present invention provides for apparatus which is adapted for producing a confectionery product according to the processes as herein above described. WO2005056272 discloses an apparatus for producing an extrudated product including a plurality of capillary channels. WO2008044122 discloses a related apparatus, which additionally includes means for quench cooling an extrudate as it exits the die. Both of these apparatus may be employed/adapted for use in producing the confectionery in accordance with the present invention.

### DETAILED DESCRIPTION OF THE INVENTION

Specific embodiments of the present invention will now be described, by way of example only, with reference to the accompanying drawings, in which:

FIG. 1 is a schematic diagram illustrating the overall apparatus used for the experiments described in Examples 1 and 2, in accordance with the present invention;

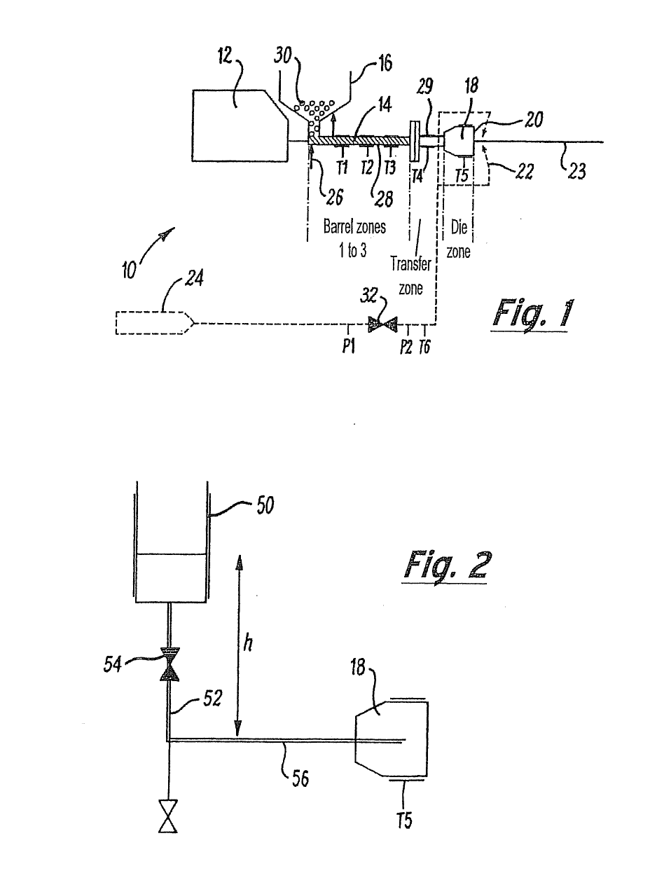

FIG. 2 is a schematic diagram illustrating the apparatus which can be used in conjunction with the apparatus shown in FIG. 1, so as to provide a liquid filled capillaries;

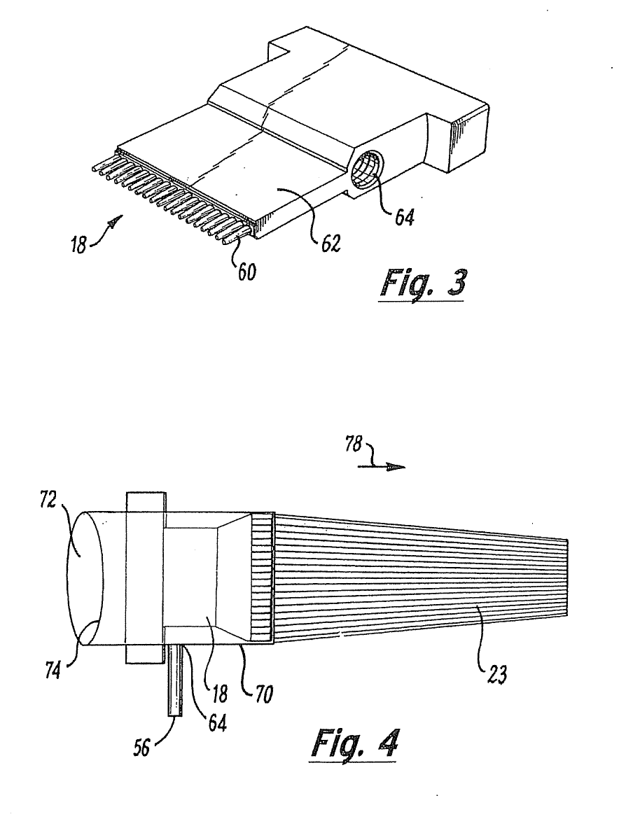

FIG. 3 is a photograph of the extrusion die used to form capillaries in the extruded material of Examples 1 and 2;

FIG. 4 is a plan view of the extrusion die which incorporates the extrusion die shown in FIG. 3 in the apparatus as illustrated in FIGS. 1 and 2;

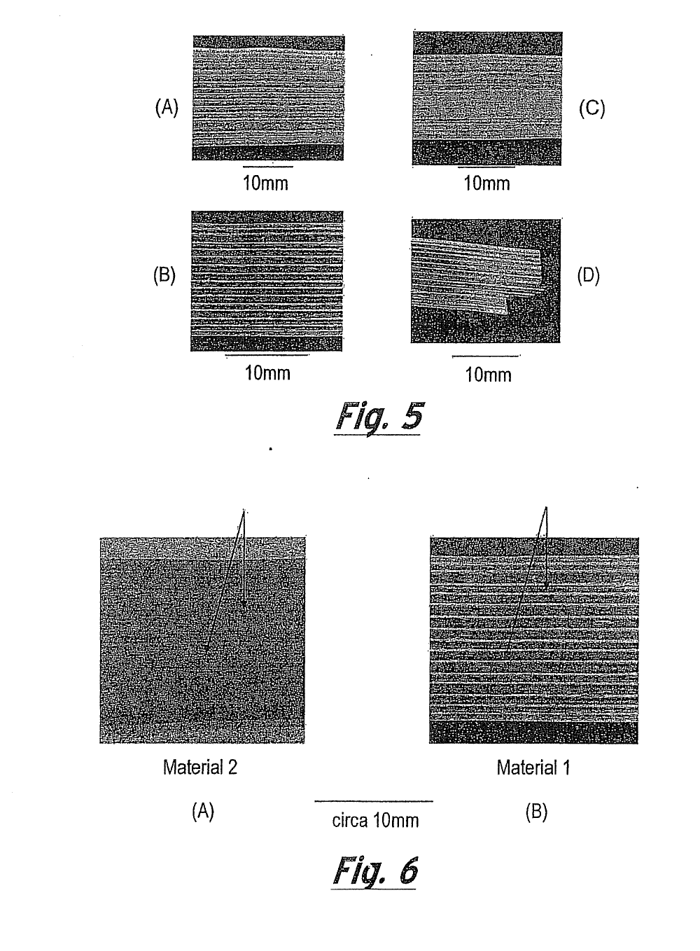

FIG. 5 shows photographs of four capillary extrudates formed from material 1 in Example 1, the photographs show: (A) low voidage, (B) and (C) high voidage and (D) very high voidage;

FIG. 6 shows photographs comparing capillary extrudates formed from (A) material 2 containing completely filled cocoa butter capillaries and (B) material 1 formed with air filled capillaries;

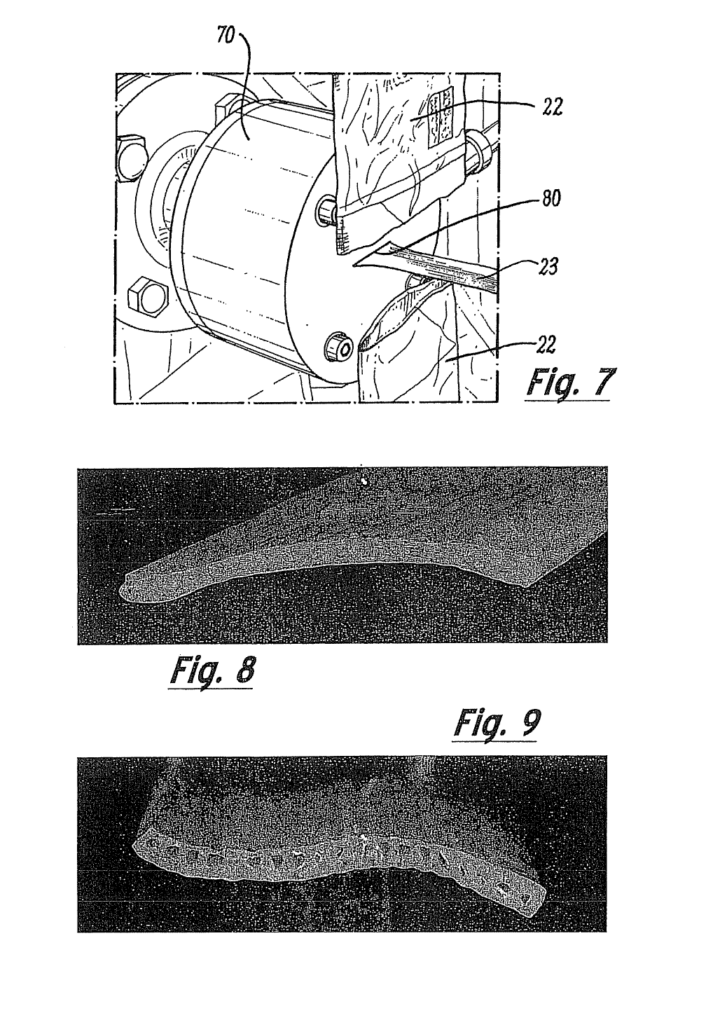

FIG. 7 shows a photograph of the external part of the extrusion apparatus as illustrated in FIGS. 1 and 2, showing the air knives used to cool the extrudate when it exist the die;

FIG. 8 shows a hard candy with an air fill produced in Example 2, in accordance with the present invention;

FIG. 9 shows a hard candy with a liquid fill produced in Example 2, in accordance with the present invention;

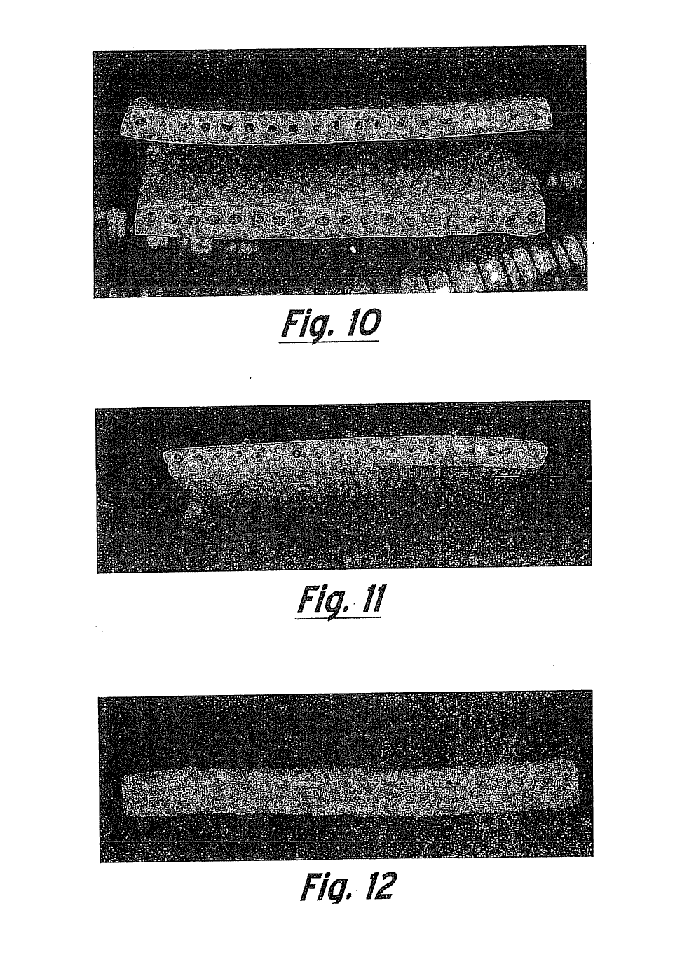

FIG. 10 shows a gum with an air fill, produced in Example 2, in accordance with the present invention;

FIG. 11 shows a gum with a liquid fill, produced in Example 2, in accordance with the present invention;

FIG. 12 shows a gum with a solid fill, produced in Example 2, in accordance with the present invention;

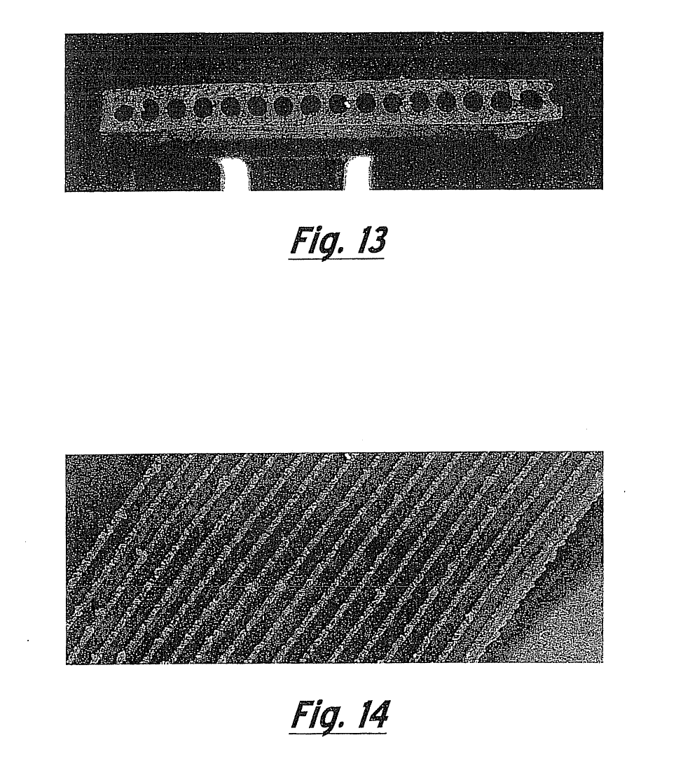

FIG. 13 shows a chocolate with an air fill, produced in Example 2, in accordance with the present invention;

FIG. 14 shows a chocolate with an air fill as shown in FIG. 13, but in longitudinal cross section;

FIG. 15A shows a perspective view of an extrudate formed in accordance with the present invention, where the extrudate has been folded;

FIG. 15B shows a cross-sectional view of the extrudate as shown in FIG. 15A, viewed from the line denoted “X”;

FIG. 16 shows a perspective view of an extrudate formed in accordance with the present invention, where a number of extrudated layers have been stacked upon one another;

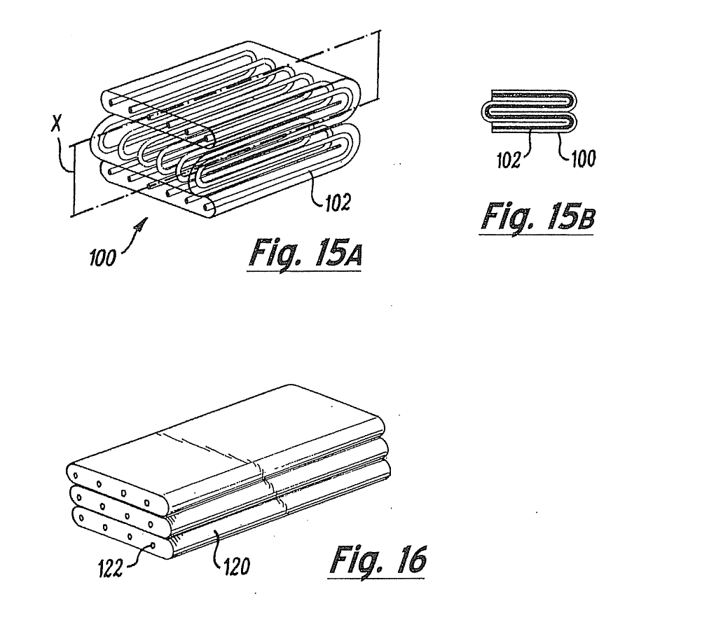

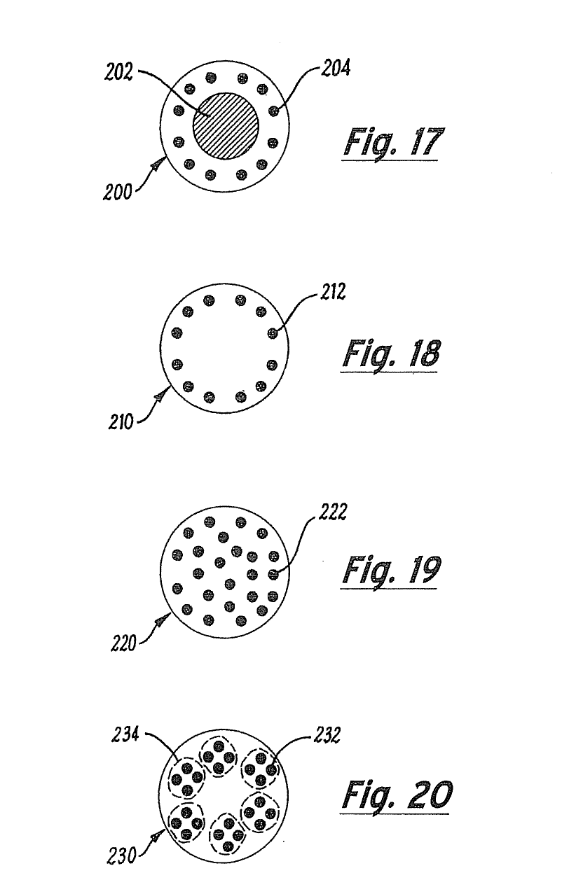

FIG. 17 shows a cross-sectional view of a confectionery product in accordance with the present invention, where the capillaries are arranged around the periphery of the product and surrounding a centre fill;

FIG. 18 shows a cross-sectional view of a confectionery product in accordance with the present invention, where the capillaries are arranged around the periphery of the product;

FIG. 19 shows a cross-sectional view of a confectionery product in accordance with the present invention, where the capillaries are arranged throughout the interior of the product;

FIG. 20 shows a cross-sectional view of confectionery product in accordance with the present invention, where groups of four capillaries are formed around the periphery of the product;

FIG. 21 shows a cross-sectional view of a confectionery product in accordance with the present invention, where capillaries of different shapes surround a large centre-filled cavity;

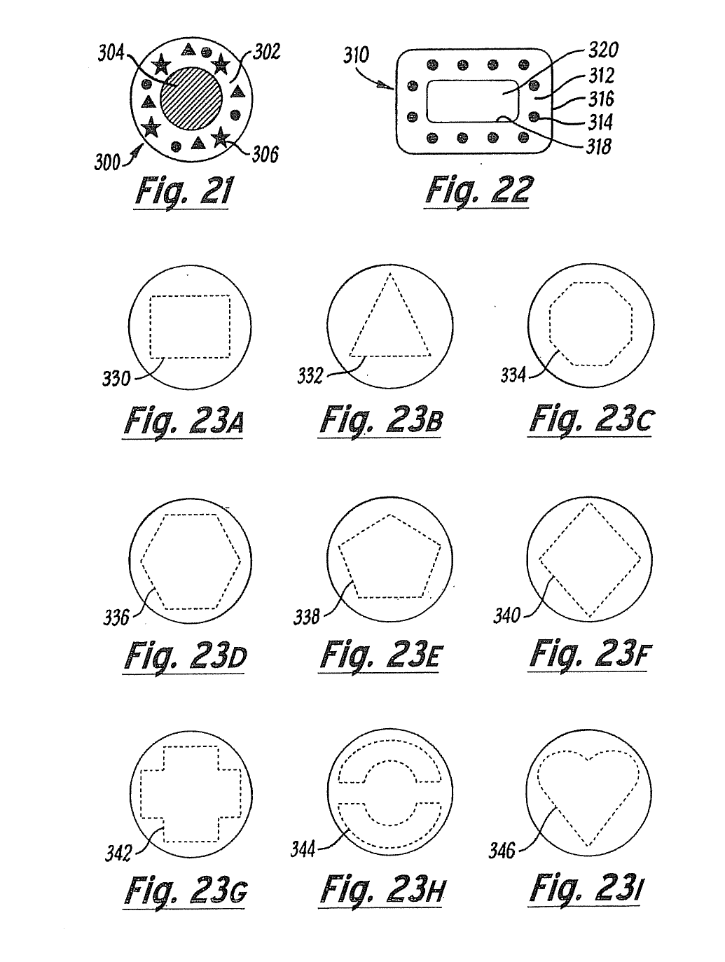

FIG. 22 shows a cross-section view of a confectionery product in accordance with the present invention, where uniformly distributed capillaries surround a large empty cavity;

FIGS. 23A-23I show cross-sectional views of a confectionery product in accordance with the present invention, where the capillaries are arranged in a number of shapes (generally shown as a dotted line for clarity) around the periphery of the product. FIG. 23A shows the shape of a square, FIG. 23B shows the shape of a triangle, FIG. 23C shows the shape of an octagon, FIG. 23D shows the shape of a hexagon, FIG. 23E shows the shape of a pentagon, FIG. 23F shows the shape of a diamond, FIG. 23G shows the shape of the outline of a cross; FIG. 23H shows the shape of two semi-circular curves and FIG. 23I shows the shape of a heart;

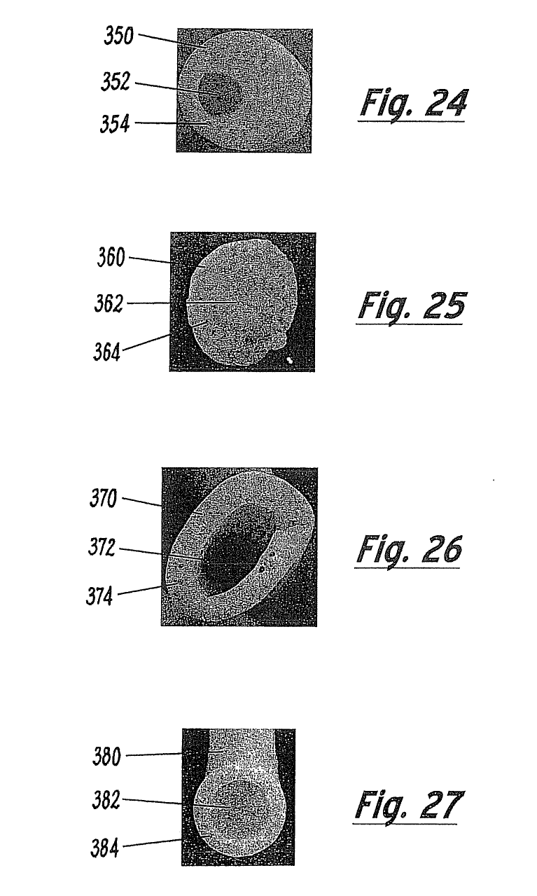

FIG. 24 is a photograph showing a cross-section of a product made in accordance with the present invention, having an extruded hard candy body portion with a central cavity and a plurality of capillaries located around the periphery;

FIG. 25 is a photograph showing a cross-section of the product shown in FIG. 24, where the capillaries are filled with a glucose syrup and the cavity is filled with a fondant filling;

FIG. 26 is a photograph showing a cross-section of a product made in accordance with the present invention, having an extruded chewy candy body portion with a central cavity and a plurality of capillaries located around the periphery; and

FIG. 27 is a photograph showing a cross-section of a product made in accordance with the present invention, having an extruded gum body portion with a central cavity and a plurality of capillaries located around the periphery.

Experiments were conducted to produce a variety of confectionery products incorporating capillaries. Three phases of extrusion work were undertaken using various materials. The first phase concerned the extrusion of hard candy using a capillary die attached to a small-scale extruder in a non-food grade environment for creating capillary candy extrudates in both low- and high-voidage forms. The second phase of the experimental work built upon the first phase to produce low and high voidage candy capillary extrudates containing an array of cocoa-butter filled capillaries. The first and second phases are described below in Example 1. The third phase built upon the first two and recreated the working environment with food grade equipment in a food grade environment and is described below in Example 2.

### EXAMPLE 1

Phase one concerned the extrusion of candy using a capillary die attached to a small-scale extruder, in order to confirm that candy having capillaries with both low and high voidage values could be formed in accordance with the present invention.

The materials that were trialed during this investigation are shown in Table 1.

TABLE 1
Materials tested.

| Material | Material | | |
|---|---|---|---|
| number | name | Majority ingredients | Application |
| 1 | Custom | Sugar (40%) Glucose | Extruded matrix |
| | recipe 1 | Syrup (60%) | |
| 2 | Custom | Maltitol syrup (96%) Gum | Extruded matrix |
| | recipe 2 | Arabic (2%) Water (2%) | |
| 3 | Cocoa butter | Cocoa butter (100%) | Capillary filler |

Materials 1 and 2 were supplied as large solid blocks. All materials were crushed prior to extrusion to yield a fine granular powder, with grain sizes ranging between 1 mm and 5 mm. Material 3 was supplied as a tub of solidified cocoa butter; the required quantity was broken up into a fine powder containing only small lumps before being fed into the heated cocoa butter reservoir.

The extrusion equipment consisted of a Betol single screw extruder, with a screw diameter of approximately 12 mm, and a screw L/D ratio of roughly 22.5:1. The extruder had four different temperature zones (denoted T1-T4 in FIG. 1 as described later), each of which could be independently controlled using PID controllers connected to band heaters. The Mk 3 MCF extrusion die, containing an entrainment array consisting of 17 hypodermic needles, was connected on the extruder endplate. Two opposed air jets, used to rapidly quench the extrudate emerging from the extrusion die, were placed above and below the die exit; these jets were connected via a valve to a compressed air line at 6 Barg. A schematic diagram showing the general layout of the extrusion line is shown in FIG. 1 and a schematic drawing of the capillary die is shown in FIG. 2.

With reference to FIG. 1, there is shown a schematic diagram of the extrusion apparatus 10 used in the experiments. The apparatus briefly comprises an electric motor 12 which is rotatably coupled to an extrusion screw 14. The screw 14 is fed at one end by a hopper 16 and the opposing end is coupled to an extrusion die 18 having an extrudate outlet 20. Quench jets 22 are directed towards the die outlet 20 so as to cool the extruded material 23 which is produced and these jets are fed with compressed air 24. If desired, the area of the apparatus where the hopper 16 is coupled to the screw 14 can be cooled by means of a cooling feed 26. Surrounding the screw 14 is a barrel 28 which is formed having three barrel temperature zones denoted T1 to T3—the temperatures of each zone being capable of being controlled. The barrel 28 is connected to the die 18 by means of a feed conduit 29 which also has a temperature zone T4 which can be controlled.

In use, the hopper 16 is filled with material 30 (such as candy in solution) which can be heated so as to render it (or maintain it as) a liquid (anything other than a solid or solid particulates). Before the material passes into the screw 14, it can be cooled by means of the cool feed 26, so as to ensure that the material is at the correct temperature for entering the screw extruder. As the screw is rotated, the liquid material is drawn along the screw 14, inside the barrel 28 and the temperature of the zones T1-T3 adjusted accordingly. The material then passes through the feed conduit 29 and the temperature adjusted again (if required) by temperature control T4 before entering the die 18. The die 18 (shown in FIG. 3) has a number of needles (not shown) located within an entrainment body so that the material passes over and around the needles. At the same time that the material is being extruded, compressed air 24 is forced through the needles so that the extrudate contains a number of capillaries. The extrudate 23 is cooled by means of the quench jets 22 as it is released from the die 18. A valve 32 controls the flow of compressed air to the apparatus and pressure devices P1 and P2 control the pressure of the compressed air 24 before and after the valve. The compressed air line also has a temperature control T6 so as to control the temperature of the air before entering the die.

With reference to FIG. 2, there is shown an adaptation of the apparatus shown in FIG. 1. Rather than compressed air 24 being forced through needles, the needles are connected to a reservoir 50 containing cocoa butter. The reservoir 50 is heated so that the cocoa butter is maintained at the correct temperature so as to maintain it in a liquid state. The reservoir 50 is connected to a conduit 52 having an isolation valve 54 for controlling the flow of liquid. The conduit 52 is encased in a trace heating tube 56 which maintains the temperature of the conduit so that the liquid remains in a liquid state during its movement within the conduit. The conduit 52 is coupled to the inlet to the die 18 having number of needles, so that when the material is being extruded, the capillaries formed around and the needles can be simultaneously filled with cocoa butter. Of course, the capillaries could be filled with other types of liquid material if desired.

FIG. 3 shows the die 18 in more detail. In particular, this figure shows that the metallic die 18 has, at one end, a plurality of needles 60 which are joined to a cavity 62 which is in fluid communication with an inlet channel 64 for pumping a fluid material into the capillaries of the extrusion.

With reference to FIG. 4, there is shown the die 18 in place in an entrainment body 70. Molten material 72 enters an opening 74 of the entrainment body 70 and the material is forced over and around the needles 60 of the die 18. At the same time, either air or liquid cocoa butter enters the die inlet by means of a fluid feed conduit 56. When operational, the molten material is extruded through the entrainment body 70 over the needles 60 of the die 18. Either air or cocoa butter is then pumped through the needles at the same time so as to produce an extrudate 23 (in direction 78) which either has capillaries with no filling or capillaries filled with cocoa butter.

FIG. 7 shows the entrainment body 70 having an opening 80, through which the extrudate is formed. This figure also shows two quench jets 22 located above and below the aperture so as to cool down the extrudate after is has been produced.

In use, the flow of molten material over the tips of the entrainment nozzles (hypodermic needles) caused a small area of low pressure to form at each needle tip. Each nozzle was connected together via internal channeling within the entrainment body. These, in turn, were connected outside the extrusion die to either air at room temperature and pressure or to a molten cocoa butter reservoir, with a hydraulic head of h in FIG. 2. The pipework connecting the die to the cocoa butter reservoir and the cocoa butter reservoir was externally heated to maintain the cocoa butter in the liquid phase. A set of isolation valves were used to switch between either using an air feed to the entrainment body or a molten cocoa butter feed. This is shown schematically in FIG. 2.

The quench jets were used for the generation of the high-voidage material. Differential scanning calorimetry (DSC) was used to examine the thermal behaviour of the materials, such that information relating to the phase transition temperatures could be obtained.

Material 1 was formed in a large solid block. The block was broken up mechanically, such that it became a granulated material with granule sizes between 1 mm and 5 mm.

The extrusion temperature profile was set to that shown in below Table 2.

TABLE 2
Extruder temperature profile for material 1.

| Temperature zone | Label on FIG. 1 |
|---|---|
| Barrel zone 1 | T1 |
| Barrel zone 2 | T2 |
| Barrel zone 3 | T3 |
| Die zone 1 | T4 |
| Die | T5 |

Granulated pieces of material 1 were starve-fed into the extruder, with the extruder screw-speed set to 40 rpm. The granules of material 2 conveyed well into the extruder in the solid phase initially, but due to the sticky nature of the material, some mild feed zone bridging and blocking was observed. This was overcome by gently pushing the broken-up material onto the extruder screw with a polyethylene rod.

Successful capillary extrudates were easily achievable using this protocol. The material had good melt strength and was pulled away easily from the die in the molten state before it set into a brittle, glassy, material. The glassy state of the material meant that it was unsuitable for use in a pair of nip rolls since the compression experienced by the material in this apparatus caused fracture. Consequently, the capillary extrudates from material 1 were hand drawn, the capillaries having an average diameter (width) of less than 4 mm.

Low voidage MCF from material 1 was easily obtained without quenching the extrudate using the quench jets; this is illustrated in the photograph in FIG. 5(A). Enhanced manual hauling of the extrudate away from the die exit coupled with use of the quench jets resulted in high voidage capillary being extruded. The ultimate voidage depended on the speed at which material is hauled away from the die; various different forms of high voidage capillary extrudate formed from material 1 are shown in FIGS. 5(B), (C) and (D). Crude optical analysis of the cross section of material similar to those shown in FIGS. 10 (B) and (C) revealed that voidage between 35% and 40% had been generated. It is highly likely that the high voidage material shown in FIG. 10 (D) was in excess of the value of 35% o 40%.

The second phase of the of extrusion experiments were conducted with material 1 using cocoa butter heated to between 35° C. and 40° C. The head, h, of the cocoa butter reservoir was initially set to 8 cm, and material two fed into the extruder as described earlier. The initial proof of concept was successful, and resulted in the partial filling of the capillaries with molten cocoa butter. It was observed, however, that due to the increased viscosity of the cocoa butter compared to air, the rate at which cocoa butter could be entrained into the extrudate was slow. This problem appeared to be solved by increasing the head of the reservoir to 21.5 cm. It was also observed qualitatively that, in low voidage form, the cocoa-butter filled capillaries appeared somewhat smaller than their air-filled counterparts (less than 3 mm compared to less than 4 mm). It was also possible to create high-voidage cocoa-butter filled capillary extrudates, subject to the cocoa-butter head being high enough to supply molten cocoa butter at the increased rate.

Material 1 was successfully formed into capillary extrudates, of both high and low voidage, with either airfilled capillaries or cocoa butter-filled capillaries. Varying different voidages films were made, and it was observed that increasing levels of voidage led to increasing fragility. A representative figure for one of the high voidage air-cored films was between 35% and 40% and it is estimated that the very high voidage, highly fragile films, exceeded this.

Material 2 was formed from a mixture of 96% maltitol syrup, 2% gum Arabic, 2% water. Material 2 was shown to act in a similar manner to material 1, in that it was supplied in a large block that was required to be broken up mechanically into smaller granules before it could be fed into the extrusion line. Prior to extrusion experiments commencing, the extrusion die was disassembled and washed and the extruder was fed a hot water wash to dissolve any material 1 remaining within the extruder barrels or on the screw. After the water was purged from the extruder, the extruder was heated to 130° C. for between five and ten minutes to evaporate any remaining water. An early scoping experiment revealed that material 2 required higher extrusion temperatures than material 1; the final extrusion line temperature profile is shown in Table 3 below.

TABLE 3
Extruder temperature profile for material 2.

| Temperature zone | Label on FIG. 1 | Temperature (° C.) |
|---|---|---|
| Barrel zone 1 | T1 | 115 |
| Barrel zone 2 | T2 | 115 |
| Barrel zone 3 | T3 | 115 |
| Die zone 1 | T4 | 115 |
| Die | T5 | 120 |

As with material 1, material 2 was starve-fed into the extruder. As with material 1, the screw speed was set to 40 rpm. Material 2 proved to be easy to extrude and capillary extrudates with air-filled capillaries were produced in both low and high voidage forms. Material 2 exhibited good melt strength, good drawing characteristics prior to solidifying and became brittle and glassy upon solidification. Again, this precluded the use of nip rollers to draw the material from the die and control the amount of draw down achieved, hence manual drawing was used in a similar way to material 1. In terms of restarting the extrusion line after an idle period, material 2 did not prove to be noticeably different to material 1, and the line restarted relatively easily. Due to the ease with which capillary extrudates were achieved, phase one was concluded relatively quickly to allow progression to phase two.

Phase two experiments were conducted with material 2 using cocoa butter heated to between 35° C. and 40° C. The head, h, of the cocoa butter reservoir was kept at 21.5 cm, and material 2 starve-fed into the extruder as described in the previous section. Successful extrusion of both low- and high-voidage micro capillary extrudate from material 2 containing completely filled cocoa-butter capillaries was achieved. A photograph comparing the cocoa-butter filled capillaries of material 2 to the air filled capillaries of material 1 is shown in FIG. 6. Crude optical analysis of a cross section of a piece of high-voidage material 2 revealed that the voidage was roughly 35% at minimum. It is likely this figure can be easily increased through optimisation of the protocol.

The observations for material 2 are similar to those from material 1. Low- and high-voidage capillary extrudates were formed, either containing cocoa-butter capillaries or air-filled capillaries. Crude optical analysis of a moderately high-voidage extrudate revealed that the void fraction was approximately 35%.

Although, it is thought that the actual figure may have been higher. Increasing product voidage again led to increasing product fragility due to the capillary walls becoming very thin.

The objective of these first and second phase experiments were to provide proof-of-concept for the extrusion of capillary extrudates from various candy materials. This was successful with both materials (material 1=40% sugar and 60% glucose, and material 2=96% maltitol syrup, 2% gum Arabic and 2% water). Low- and high-voidage capillary extrudates were formed containing both air-filled capillaries and cocoa-butter filled capillaries. It was estimated that a typical high-voidage extrudate contained roughly 35% to 40% voidage whether it was air filled or cocoa-butter filled.

### EXAMPLE 2

The third phase built upon the first two phases described in Example 1 and recreated the working environment with food grade equipment in a food grade environment. This food-grade setup extruded hard candy, chocolate and chewing gum with air, liquid and solid centres. This range of filled extrudates were made in a food grade environment and were consumed to investigate their edible properties.

The following edible materials were used in these experiments: Chewing gum (uncoated Peppermint-Spearmint Higher flavour chewing gum pellets); hard candy, mint candy (Extra Strong Mints®, Jakemans® Old

Favourites), fruit candy (Summer Fruits, Jakemans® Old Favourites), chocolate (milk chocolate (with 0, ½, 1, 2% added water), Cadbury® Dairy Milk® Buttons—when used molten, 2% PGPR was added to lower the melt viscosity for ease of use (c.f. legal limit of ½%)), compound chocolate (Plain Belgian Chocolate, SuperCook®), 72% Cook's Chocolate, Green & Black's®. Liquid fillings used in these experiments included: monopropylene glycol (Propane-1,2-diol, BP, EP, USP, Fisher scientific®—selected for low viscosity, zero moisture, low flavour, and BP, EP & USP grade for oral use), Golden Syrup (partially inverted refiners syrup—Tate & Lyle®—selected for higher viscosity, food grade, shelf stability, and sweet flavour), Red Food Colouring (SuperCook®, UK), Blue Food Colouring (SuperCook®, UK). Lastly, a solid filling of cocoa butter obtained internally from a Cadbury Plc. site was also used in these experiments and this was selected because it is solid at room temperature and has low hot viscosity.

A Davis-Standard HPE-075 ¾″ 24:1 single-screw extruder was used in these experiments. The extruder also included air-knives and a header tank. The screw was a simple conveying-compression-pumping all forward element design, with no mixing or reversing sections. The motor was 3 KW, geared to produce 0-100 rpm screw rotation. The feed throat was jacketed and supplied with flowing ambient water to prevent heat transfer from the barrel causing feed problems with sticky feedstuff. The barrel had three heating zones, each with a 1 KW heater and forced ambient air cooler. The standard extruder has a Eurotherm 3216 controller per barrel zone and one spare for the die (die controller connected to thermocouple input and standard 16 A 240 v socket for up to 1 KW heater output).

At point of purchase, two additional die controllers, thermocouple inputs and heater outputs were specified to enable integrated control of the header tank containing filling material and the pipework connecting that header tank to the die. The die was an assembly of parts comprising a body with main die orifice of long thin rectangular shape, through which 19 interconnected nozzles (similar in size to hypodermic needles) also exited. The main body was heated and the nozzles led to an external fitting that could be opened to ambient air or could be connected to the heated, pressurized header tank. A bobbin shaped flange was constructed to mount the die assembly onto the extruder end flange.

The die was heated with 4×100 W ¼″ cartridge heaters, and monitored by a K-type thermocouple probe. Initially these were controlled by a Eurotherm 3216 in a bespoke enclosure until the control and power wiring was transferred to a Eurotherm integrated into the extruder. The die assembly was earthed into the power outlet from the extruder.

The header-tank and the pipework connecting the header tank to the die were heated with two 100 W ribbon heaters initially controlled from a single analogue controller in a bespoke enclosure, and monitored by a single bare K-type thermocouple. These were later separated to two Eurotherm 3216s integrated into the extruder with two thermocouples and two power supplies. The header tank was earthed to the power outlet, whilst the pipework was plastic and did not need to be earthed.

Compressed air, BOC®, UK was regulated with series 8000 gas regulator and pressures used were 0-10 bar. The main use for the compressed air was to supply the air-knives.

Food Safe High-Tech Grease, and Food Safe Penetrating Oil from Solent Lubricants, Leicester, UK was used.

The capillary die was connected on the extruder endplate. Two opposed air knives were used to rapidly quench the extrudate emerging from the extrusion die, were placed above and below the die exit; these jets were connected via a valve to a compressed air line at 10 bar pressure. A schematic diagram showing the general layout of the extrusion line is shown in FIG. 1.

In use, the flow of molten material over the tips of the entrainment nozzles (hypodermic needles) caused a small area of low pressure to form at each needle tip. Each nozzle was connected together via internal channeling within the entrainment body. This, in turn, was connected outside the extrusion die to either air at room temperature and pressure or to a header tank containing a liquid that was at ambient or elevated temperature and pressure, with a hydraulic head of h. The header tank and the pipework connecting to the die were externally heated. A set of isolation valves were used to switch between either using an air feed to the entrainment body or a molten cocoa butter feed. This is shown schematically in FIG. 2.

The quench jets were used for the generation of the high-voidage material. It had been found during previous research that if the emerging extrudate was quenched very rapidly and subjected to a high drawing force, a higher voidage cross section could be obtained. Adjustment of the polymer and process conditions yielded voidages up to, and possibly in excess of, 60%.

Hard candy was pre-broken before introduction to the extruder. Particle size was not important—the extruder was found to take whole candies or dust. It was found that broken candies fed more evenly than whole pieces. All barrels and the die were set to 95° C. for fruit candy. Mint candy had tolerance to a wide range of temperatures and could run with barrels and die at 95°-110° C.

Screw speeds of 15-100 rpm were used in the experiments. Differences in product were minimal (except rate of production). Continuous, complete, transparent films with well formed capillaries could be produced optimisation of the protocol. The films could be filled and/or drawn without leaking. Product morphology was found to change with drawing speed and rate of cooling inline. Fast drawing with no cooling could thin the films to 1 mm wide with microscopic width and capillaries. Drawing with heavy cooling enlarged the voidage in the films.

In another test, uncoated gum pellets were reduced in size to approximately 3 mm to aid feeding into the extruder. This was done with freezing and a domestic food processor. Barrel and die temperatures of 58° C. resulted in the most contiguous product. This product had sufficient integrity to be filled with few leaks. It is likely that using gum base, in particular molten gum base, rather than whole gum would produce films with even greater integrity.

In a further test, chocolate was used as material for extrusion. To gain stable running conditions, the heaters and cooling fans of the extruder were electrically disabled. Direct temperature control was abandoned in favour of relying on the air conditioning of the laboratory. With these modifications the extruder barrel indicated an even 22° C. and it was simple to extrude capillary chocolate in a steady state using molten tempered Cadbury's Dairy Milk® chocolate.

As with hard candy extrusion, it was possible to draw the chocolate extrudate so as to alter the cross sectional geometry, and produce capillaries having diameters or widths of between 0.5 mm and 4 mm.

Air filling was achieved through a simple ambient air-bleed to the nozzles in the die and a cross section of the extrudate is shown in FIG. 8.

Monopropylene glycol filling was achieved at ambient temperature and pressure, with approximately 5 cm liquid depth in the header tank which was in turn approximately 10 cm higher than the die. Colour was added directly into the header tank as and when required.

Golden Syrup filling was achieved by heating the header tank and pipework to 78° C. to fill hard candy, and 58° C. to fill gum. Pressurisation of the header tank was required at the lower temperature to generate syrup flow. Again, colour was added directly into the header tank as and when required.

FIGS. 8-14 shows photographs of extrusions formed in the third phase of experiments. FIG. 8 shows a hard candy with an air fill. FIG. 9 shows a hard candy with a liquid fill. FIG. 9 shows a gum with an air fill. FIG. 10 shows a gum with a liquid fill. FIG. 11 shows a chocolate with an air fill. FIG. 12 shows a chocolate with an air fill as shown in FIG. 11, but in longitudinal cross section.

Confectionery products and methods of the invention have been shown for chocolate, hard candy and gum. The experiments of the third phase had shown a range of food materials that can also be used. It could therefore be deduced that any product normally solid at room temperature yet extrudable at elevated temperature and pressure could be formed into a capillary product such as chewy, gummy or jelly candies, for example. Products that show high extensional viscosity when warm may be drawn to alter their geometry and their outer to inner ratio.

It has also been shown that air, liquid and solid centres can be incorporated into capillary extrusions, providing the solid centre can be liquefied and is flowable.

It will be apparent to the skilled addressee that the capillary extrudate produced in the examples could be employed in confectionery in a number of ways. For example, a chocolate extrudate having capillaries filled with air could be used to manufacture a chocolate bar having a similar size to a regular bar, but lower in fat and sugar—as it contains less material. Alternatively, a chocolate extrudate could have capillaries filled with a liquid chocolate filling so as to provide an enhanced sensory pleasure. A further example may be a milk chocolate extrudate having capillaries filled with a dark chocolate filling, so as to produce a different flavour profile.

The extrudates of the present invention could be configured in a number of ways. For example, FIGS. 15A and 15B show an extrudate 100 having centre filled capillaries 102, where the extrudate is folded back on it self several times. Such a configuration would enable an extended release of centre fill during chewing. A chocolate éclair could be formed having a chewy centre having liquid filled capillaries—where the chewy centre was a folded several times so as to enable the liquid fill to be released over an extended period.

FIG. 16, shows multiple layers of extrudate 120 being stacked on top of one another and each stack having a plurality of capillaries 122 with a centre filling. Such an arrangement could also be employed in a chewy confectionery.

FIGS. 17-20 illustrate a small number of confectionery products which can be made according to the present invention.

FIG. 17 shows a cylindrical confectionery product 200 having a circular cross-section. In a central portion of the product, there is provided a liquid centre fill 202. A number of uniformly spaced capillaries 204 extend around the periphery of the product and surround the liquid centre fill 202. A hard centre fill may be used to replace the liquid fill 202, if desired. The capillaries can be filled with a suitable fill material.

FIG. 18 shows a cylindrical confectionery product 210 having a circular cross section. A number of uniformly spaced capillaries 212 extend around the periphery of the product. The capillaries can be filled with a suitable fill material.

FIG. 19 shows a cylindrical confectionery product 220 having a circular cross section. A number of uniformly spaced capillaries 222 extend throughout the interior of the product. The capillaries can be filled with a suitable fill material.

FIG. 20 shows a cylindrical confectionery product 230 having a circular cross section. A number of capillaries 232 extend around the periphery of the product. However, four capillaries are grouped together in a discrete zones indicated by the dotted line denoted 234. Each discrete zone of capillaries may contain different fill materials so as to provide a confectionery product having a novel taste/texture profile.

With reference to FIG. 21, there is shown an extruded confectionery product 300 having a circular body 302 made from a hard candy and having a large central cavity 304. Capillaries 306 are arranged around the periphery of the circular body and have differently shaped cross-sections (stars, triangles and circles). The capillaries 306 are filled with glucose syrup, whereas the cavity 304 is filled with a liquid fondant. The capillaries and cavity are filled during the extrusion process.

The product produces a pleasant eating experience as once in the mouth, the hard candy body starts to dissolve, which allows the glucose syrup to present a sweet sensation before the liquid fondant in the cavity is ultimately released.

With reference to FIG. 22, there is shown a chewy candy confectionery product 310. The product is formed having an extruded body 312 having a rectangular hollow cross-section. A number of capillaries 314 are disposed throughout the body 312 in a uniform manner, the capillaries 314 being located equidistant from each other and from the outer edge 316 and the inner edge 318 which surrounds a large central rectangular cavity 320. The capillaries 314 are filled with a liquid fondant, but the cavity is left empty. During consumption, the product is easily deformable in the mouth due to the large empty cavity 320 and during chewing bursts of liquid fondant flavour is expelled from the capillaries 314.

Turning now to FIGS. 23A-23I, there is shown a confectionery product having a generally circular cross-section. Each figure shows a dotted line which outlines a particular shape which could be formed in the extrudate by extruded capillaries generally around the dotted lines. FIG. 23A shows the outline of a square 330, FIG. 23B shows the outline of a triangle 332, FIG. 23C shows the outline of an octagon 334, FIG. 23D shows the outline of a hexagon 336, FIG. 23E shows the outline of a pentagon 338, FIG. 23F shows the outline of a diamond 340, FIG. 23G shows the outline of the outline of a cross 342; FIG. 23H shows the outline of two semi-circular curves 344 and FIG. 23I shows the outline of a heart 346. Of course, a number of other shapes could also be formed in the extrudate, for example cartoon and animal figures.

In FIG. 24, a photograph shows a cross-section of a confectionery product which has a similar shape and configuration to that shown in FIG. 17, and the product is formed from an extruded hard candy body portion 350 with a round central cavity 352 and a plurality of capillaries 354 located around the periphery.

In FIG. 25, a photograph again shows a cross-section of a product which has a similar shape and configuration as shown in FIG. 17, the product being formed from an extruded hard candy body portion 360, with a round central cavity 362 containing a liquid fondant filling. Capillaries 364 are located around the periphery and these include glucose syrup.

In FIG. 26, a photograph again shows a cross-section of a product which has a similar shape and configuration as shown in FIG. 17, the product here being formed from an extruded soft candy body portion 370, with a round central cavity 372 and a plurality of capillaries 374 located around the periphery.

In FIG. 27, a photograph yet again shows a cross-section of a product which has a similar shape and configuration as shown in FIG. 17, the product here being formed from an extruded gum body portion 380, with a round central cavity 382 and a plurality of capillaries 384 located around the periphery. If desired, the cavity 382 and capillaries 384 may be filled with contrasting materials.

The foregoing embodiments are not intended to limit the scope of protection afforded by the claims, but rather to describe examples as to how the invention may be put into practice.

1. A confectionery product comprising an extruded body portion, the body portion having three or more capillaries disposed therein which extend substantially parallel to one another in two or more different planes, the capillaries being distributed in groups at one or more locations within the body portion and/or distributed around the periphery of the body portion.

2. A confectionery product as claimed in any preceding claim, wherein the capillaries are distributed throughout the body portion in a substantially circular, semi-circular, elliptical or polygonal configuration.

3. A confectionery product as claimed in claim 1, wherein the capillaries are distributed substantially uniformly throughout the body portion.

4. A confectionery product as claimed in any preceding claim, wherein the capillaries have an average width or diameter of no more than 3 mm.

5. A confectionery product as claimed in any preceding claim, wherein the capillaries are filled with a fluid material.

6. A confectionery product as claimed in claim 5, wherein the fluid comprises a liquid.

7. A confectionery product as claimed in claim 5, wherein the capillaries are filled with a liquid material which solidifies.

8. A confectionery product as claimed in any preceding claim, wherein the product further comprises a coating portion to envelop the extruded body portion.

9. A confectionery product as claimed in any preceding claim, wherein the capillaries or groups of capillaries have different widths or diameters.

10. A confectionery product as claimed in any preceding claim, wherein the capillaries or groups of capillaries have different cross-sectional profiles.

11. A confectionery product as claimed in any preceding claim, wherein the body portion incorporates a central cavity.

12. A confectionery product as claimed in claim 11, wherein the central cavity has a width or diameter which is larger than the capillaries.

13. A confectionery product as claimed in any preceding claim, wherein the product further comprises a centre fill.

14. A confectionery product as claimed in claim 13, wherein the centre fill is at least partially surrounded by the capillaries.

15. A confectionery product as claimed in either claim 13 or 14, wherein the centre fill comprises a liquid centre fill.

16. A confectionery product as claimed any one of claims 13 to 15, wherein the centre fill is located in the cavity.

17. A confectionery product as claimed in any preceding claim, wherein the capillaries in the extruded body portion result in a voidage in the range of 5-99%.

18. A confectionery product as claimed in any preceding claim wherein the capillaries have an average diameter or width of no more than 2 mm.

19. A confectionery product as claimed in any preceding claim where the body portion comprises a first extruded portion and a second extruded portion, wherein each portion has a plurality of capillaries disposed therein, and the capillaries of the first and second portions are:
a) discontinuous; and/or
b) continuous and oriented in more than one direction.

20. A confectionery product as claimed in any preceding claim, wherein one or more of the capillaries are filled with a material which is different from that of the material used to form the extruded body portion.

21. A process for manufacturing a confectionery product comprising an extruded body having a plurality of capillaries disposed therein, the process comprising the step of:
a) extruding an extrudable confectionery material with three or more capillaries disposed therein which extend substantially parallel to one another in two or more different planes, the capillaries being distributed in groups at one or more locations within the body portion and/or distributed around the periphery of the body portion.

22. A process as claimed in claim 21, further comprising a step selected from:
b) cutting the extrudate into two or more pieces having a plurality of capillaries disposed therein and forming a confectionery product incorporating the pieces; or
c) folding the extrudate and forming a confectionery product incorporating the folded extrudate.

23. A process as claimed in claim 21 or 22, wherein the process further comprises the step of depositing a filling in at least part of one or more of the capillaries.

24. A process as claimed in any one of claims 21 to 23, wherein the filling is deposited during the step of extrusion.

25. A process as claimed in any one of claims 21 to 24, wherein the filling comprises a fluid.

26. A process as claimed in claim 25, wherein the fluid comprises a liquid.

27. A process as claimed in claim 26, wherein the liquid solidifies after deposition.

28. A process as claimed in any one of claims 21 to 27, wherein the process further comprises the step of quench cooling the extrudate after extrusion.

29. A process as claimed in claim 28, wherein the quench cooling uses a fluid.

30. A process as claimed in any one of claims 21 to 29, wherein the process further comprises the step of, after extrusion, stretching the extrudate.

31. A process as claimed in any one of claims 21 to 30, wherein the process further comprises the step of enveloping the confectionery product in a coating.

32. A process as claimed in any one of claims 21 to 31, wherein the body portion is formed with a central cavity which has a width or diameter which is larger than the capillaries.

33. A process as claimed in claim 32, wherein the cavity is filled with a centre fill.

34. A process as claimed in claim 33, wherein the cavity is filled with the centre fill during extrusion of the body portion.

35. A process as claimed in any one of claims 21 to 34, wherein the process is for producing a confectionery material as claimed in any one of claims 1 to 20.

36. An apparatus adapted for producing a confectionery product according to the process claimed in any one of claims 21 to 34.

37. A confectionery product substantially as described herein and with reference to the accompanying drawings.

38. A process for producing a confectionery product substantially as described herein and with reference to the accompanying drawings.
